(19) United States
(12) Patent Application Publication
(10) Pub. No.: US 2008/0069300 A1
(43) Pub. Date: Mar. 20, 2008

(54) Flow Cytometer

(76) Inventor: Akira Saito, Tokyo (JP)

Correspondence Address: BIRCH STEWART KOLASCH & BIRCH, PO BOX 747, FALLS CHURCH, VA, 22040-0747, US

(21) Appl. No.: 11/632,215

(22) PCT Filed: Jul. 11, 2005
(86) PCT No.: PCT/JP05/12732

§ 371 Date: Jan. 11, 2007

(30) Foreign Application Priority Data
Jul. 14, 2004 (JP) 2004-207518

(51) Int. Cl. G01N 23/223

(52) U.S. Cl. 378/44

(57) ABSTRACT

The correlation between various elements in a particle such as a cell or a blood cell can be determined by directly measuring elements. A flow cytometer comprises sample liquid flow generating means for generating a sample liquid flow containing an object to be measured at a predetermined flow speed, monochromatic X-ray applying means for applying monochromatic X-rays constituting the object when the monochromatic X-rays are applied to the object.

### TECHNICAL FIELD

The present invention relates to a flow cytometer, and more particularly to a flow cytometer used suitably for elemental analysis.

### BACKGROUND TECHNOLOGY

Heretofore, a manner called by the name of “flow cytometry” being a technology for labeling cells, and intra- and extracellular structures (intracellular minute organs, membrane surface antigens, bacteria, viruses and the like) (these terms “cells, and intra- and extracellular structures (intracellular minute organs, membrane surface antigens, bacteria, viruses and the like) are optionally referred generically to as simply “particles” in the present application) with fluorescence to determine and separate an object to be measured has been known.

Namely, the flow cytometry means specifically a such manner that a suspension of labeled substances is made to be a high-speed stream current, and the high-speed stream current is irradiated with a laser beam or a mercury light beam, whereby the generated scattered light or the generated fluorescent is determined to precisely measure the amount and the dimension of a target substance or to batch off particles such as cells being an object to be measured.

In this connection, equipment for embodying such flow cytometry is called by the name of “flow cytometer”.

The effect of cytometry which is realized by a conventional flow cytometer will be described.

Namely, as described above, for example, the flow cytometry is a manner wherein a cell floating liquid is allowed to flow at a high speed to measure a target substance, whereby an individual cell is analyzed and investigated. In a conventional flow cytometer, it is arranged in such that first, a solution containing particles such as cells is allowed to flow, and the solution is irradiated with a laser beam to measure an individual size and an inner structure of the particles such as cells from the scattering intensity. In this case, when a relative dimension and a difference in the inner structure of each of particles such as cells are measured as well as when the fluorescence is counted from the fluorescence-labeled particles such as cells at the same time, the intensity and the differences in colors are obtained, whereby the identification of an individual cell type and an abundance ratio of a variety of cells in the solution can be determined and analyzed.

When a plurality of the information obtained as described above is combined with each other, a detailed and systematic analysis, for example, an analysis for a cell size and nuclear fluorescence or the like can be made with respect to a group of cells, and it has been a very important meaning to conduct such detailed analysis.

This is because “the correlation in increase and decrease between living body substances” in a cell group can be measured by such an arrangement that a fluorescent dye for dyeing quantitatively DNAs or proteins is used; and amounts of the respective proteins and the like are replaced by the fluorescent intensities.

However, the flow cytometry according to the conventional flow cytometer as mentioned above involves a significant problem to the effect that there is no fundamental concept of “element” with respect to the objects to be measured.

More specifically, since the content of an element itself cannot be specified generally by a fluorescent dye, a conventional flow cytometer cannot measure directly elements to process them as the parameters.

On one hand, there are a number of diseases relating to increase and decrease of characteristic elements such as a variety of tumors relating to which increase and decrease of zinc and iron are known, and Wilson's disease relating to which remarkable decrease of copper is known.

Furthermore, there are extremely various metabolisms and vital reactions relating deeply to specific elements such as drug resistances, apoptosis, nervous conduction, energy metabolism, and cell cycles.

In this respect, no elemental information is obtained by the flow cytometry using a conventional flow cytometer; while in another method, it can only point out increase and decrease of a content in a tissue level. Thus, there has been such a problem that the flow cytometry using a conventional flow cytometer does not reach a breakthrough for the mechanism of functions and phenomena of respective elements being dominant causes.

The prior art which had been known by the present applicants at the time of filing the present application is that as described above, but not an invention relating to that which had been well known from literally documents, so that there is no prior technical information to be expressed herein.

### DISCLOSURE OF THE INVENTION

Problems to be Solved by the Invention

The present invention has been made in view of the problems as described above in reference to the conventional technology, and an object of which is to provide a flow cytometer by which it becomes possible to measure directly elements, whereby a correlation between a variety of elements in particles such as cells may be obtained.

Means for Solving the Problems

In order to achieve the above-described object, the present invention improves a flow cytometer which is widely used at present for the analysis of particles such as cells to elevate remarkably the performance thereof, whereby it becomes possible to measure elements so that correlations between a variety of the elements in the particles such as cells can be obtained.

Namely, a conventional flow cytometer is arranged in such that a solution containing particles such as cells is allowed to flow, and the solution is irradiated with a laser beam to measure an individual size and an inner structure of the particles such as cells from the scattering intensity, and at the same time, the light from a coloring matter label is measured, whereby a correlated distribution is analyzed with respect to amounts of specific proteins and DNAs contained in the particles such as cells.

On the other hand, the flow cytometer according to the present invention measures directly amounts of elements, but not coloring matters, whereby it becomes possible to analyze a correlation between varieties of elements in particles such as cells.

In the flow cytometer according to the present invention, a laser beam is not used as a light source for excitation as in the prior art, but monochromatic X-rays, for example, hard X-rays of a high intensity are used, whereby fluorescent X-rays from the various elements contained in the particles such as cells are measured at the same time, so that amounts of the elements, but not coloring matters are measured directly to make the correlations between the varieties of the elements in particles such as cells to be analyzable.

Namely, the flow cytometer according to the present invention may comprises a sample liquid flow generating means for generating a sample liquid flow by flowing a sample liquid containing an object to be measured at a predetermined flow speed; a monochromatic X-ray applying means for irradiating monochromatic X-rays to the object to be measured in the sample liquid flow generated by the sample liquid flow generating means; and a fluorescent X-ray detecting means for detecting the fluorescent X-rays emitted from elements constituting the object to be measured in response to the irradiation of the monochromatic X-rays irradiated from the monochromatic X-ray irradiating means to the object to be measured.

Furthermore, the flow cytometer according to the present invention may be arranged in such that a beam diameter of the monochromatic X-rays irradiated to the object to be measured from the monochromatic irradiating means is 0.1 μm or more to 500 μm or less.

Moreover, the flow cytometer according to the present invention may be arranged in such that an incident energy of the monochromatic X-ray beams irradiated to the object to be measured from the monochromatic X-ray irradiating means is 0.1 KeV or more to 16 KeV or less.

Still further, the flow cytometer according to the present invention may be arranged is such that the sample liquid flow generating means flows the sample liquid flow inside a tube; the monochromatic X-ray irradiating means irradiates monochromatic X-rays to the object to be measured inside the tube; and a diameter of the tube is 20 to 500 μm.

### ADVANTAGEOUS EFFECTS OF THE INVENTION

Since the present invention has been constituted as described above, such excellent advantageous effects that it becomes possible to measure directly elements, whereby correlations between varieties of elements in particles such as cells become possible to obtain.

### BRIEF DESCRIPTION OF THE DRAWINGS

FIG. 1 is a conceptual, constitutional, explanatory view showing a flow cytometer according to an example of a preferred embodiment of the present invention.

FIG. 2 is a conceptual diagram showing the signal of an element (SDD spectrum with respect to one cell) obtained by the flow cytometry wherein the flow cytometer according to the present invention is used.

FIG. 3 is a conceptual diagram of a histogram showing a correlation between elements.

FIG. 4 is a conceptual diagram of a histogram showing a correlation between elements.

### EXPLANATION OF REFERENCE NUMERALS

10 flow cytometer

12 flow system

12a sample liquid containing container

12b flow cell

12c pipe

12d tube

14 monochromatic X-ray irradiating system

16 X-ray detector

18 fluorescent X-ray detecting system

20 laser beam irradiating system

22 forward-scattered light detecting system

24 side-scattered light detecting system

26 light detecting system

26a condenser lens

26b, 26c, 26d, 26e dichroic mirror

26f, 26g, 26h, 26i photomultiplier

28 batch-off system

### The Best Mode for Embodying the Invention

In the following, an example of the embodiment of the flow cytometer according to the present invention will be described in detail.

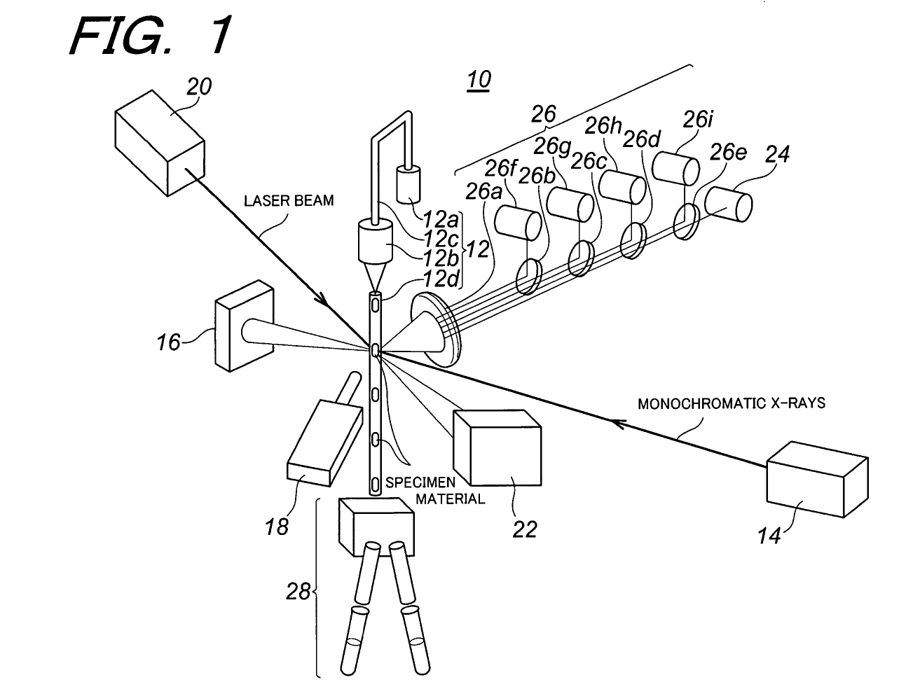

FIG. 1 is a conceptual, constitutional, explanatory view showing the flow cytometer according to an example of the embodiment of the present invention.

The flow cytometer 10 is constituted by including a flow system 12 functioning as a sample liquid flow generating means for flowing a sample liquid containing particles such as cells being an object to be measured (hereinafter referred to as “specimen material” at a predetermined flow speed to generate a sample liquid flow, a monochromatic X-ray irradiating system 14 functioning as a monochromatic X-ray irradiating means for irradiating monochromatic X-rays to the specimen material in the sample liquid flow generated by the flow system 12 and having the predetermined flow speed, an X-ray detector 16 functioning as an X-ray detecting means for detecting transmitted and scattered X-rays irradiated from the monochromatic X-ray irradiating system 14, a fluorescent X-ray detecting system 18 functioning as a fluorescent X-ray detecting means for detecting the fluorescent X-rays emitted from the respective elements constituting the specimen material in response to the irradiation of the monochromatic X-rays irradiated from the monochromatic X-ray irradiating system 14 to the specimen material, a laser beam irradiating system 20 functioning as a laser beam irradiating means for irradiating a laser beam to the specimen material in the sample liquid flow generated by the flow system 12 and having the predetermined flow speed, a forward-scattered light detection system 22 functioning as a forward-scattered light detecting means for detecting the forward-scattered light of the laser beam in response to the irradiation of the laser beam irradiated from the laser beam irradiating system 20 to the specimen material, a side-scattered light detecting system 24 functioning as a side-scattered light detecting means for detecting the side-scattered light of the laser beam in response to the irradiation of the laser beam irradiated from the laser beam irradiating system 20 to the specimen material, a light detecting system 26 for detecting the emission of a labeled coloring matter of the specimen in response to the irradiation of the laser beam irradiated from the laser beam irradiating system 20 to the specimen material, and a batch-off system 28 for batching off a predetermined specimen material in the sample liquid flow generated by the flow system 12 and having the predetermined flow speed.

As the flow system 12, a well-known system which has been heretofore known may be used except the constitution of a tube 12d which will be mentioned later. The system may be constituted from a sample liquid containing container 12a containing the sample liquid, a flow cell 12b, a pipe 12c for transferring the sample liquid contained in the sample liquid containing container 12b to the flow cell 12b, a tube 12d through which the sample liquid flow flowed out from the flow cell 12b passes, and the like components.

The tube 12d may be composed of a thin resin material such as Kapton (polyimide), Mylar, and polyethylene in such that the tube does not absorb monochromatic X-rays irradiated from the monochromatic X-ray irradiating system 14, and fluorescent X-rays emitted from the respective elements constituting a specimen material. In the case where the tube 12d is not composed from the thin resin material such as Kapton (polyimide) Mylar, and polyethylene, only the part of the tube 12d on which the monochromatic X-rays irradiated from the monochromatic X-ray irradiating system 14 are irradiated may be composed of, for example, thin beryllium, silicon nitride or the like.

Furthermore, in this case, it is preferred that the tube 12 is composed of a material which does not contain impurities generating fluorescent X-ray noises.

Moreover, a diameter of the tube 12d is preferably made to be, for example, around 20 to 50 μm in such that cells which is to be used as a specimen material can pass through the tube one by one, because a size of the cells to be used as the specimen material ranges 20 to 50 μm.

In order to obtain efficiently an yield of the fluorescent X-rays, it is possible that a plurality of cells are allowed to flow at the same time; and the signals detected are divided by the number of the cells flowed to obtain the data of one cell as in a well-known flow cytometer. In this case, a diameter of the tube 12d may be, for example, 500 μm, and an arbitrary diameter of from 20 to 500 μm is applicable.

In the case when a diameter of the tube 12d exceeds 500 μm, an X-ray beam diameter cannot cover the diameter of the tube 12d, whereby there is a case where the cells are out of the X-ray beam, so that it is not so desired.

Next, as the monochromatic X-ray irradiating system 14, for instance, an undulator (high-intensity) beam line in radiant light facilities (for example, SPring-8 which belongs to Independent Administrative Institution RIKEN, and the like) may be used. More specifically, high-intensity hard X-rays being monochromatic X-rays output from the undulator (high-intensity) beam line may irradiate onto the specimen material in the tube 12d.

A beam diameter of the monochromatic X-rays in the case where they are irradiated onto a specimen material may be, for example, 500 μm or less, and more specifically, it may be optionally set out within, for example, a range of from 0.1 to 500 μm. The reason why the beam diameter of the monochromatic X-rays is to be determined, for example, in 500 μm or less is in that there arises unnecessary scattering, resulting in a cause for generating noises, when the beam diameter of monochromatic X-rays is too large in case of irradiation of a specimen material.

On one hand, it is required that the photon density of a beam is high in order to obtain a high yield of fluorescent X-rays. Accordingly, it is desirable that the beam diameter of monochromatic X-rays is inevitably small, however, the beam diameter is appropriately determined within a range of 500 μm or less from such reasons that since a size of cells to be a specimen material is around 20 to 50 μm, the beam diameter has desirably a dimension by which the size of cells can be covered, and further that since the cells to be a specimen material flow through the inside of the tube 12d, there arises a positional deviance in the cells inside the tube 12d so that the beam diameter has desirably a dimension by which the deviated region can be covered.

In the case where an intracellular small organ such as a nucleus is applied as a specimen material, but not a cell, a beam diameter of the monochromatic X-rays to be irradiated to the specimen material may be, for example, 0.1 μm. The generation of a condensed beam having a beam diameter of less than 0.1 μm is very complex, so that it is not so desirable from the practical point of view.

On the other hand, an incident energy of a monochromatic X-ray beam may be appropriately set out with respect to a specimen material within a range of, for example, 16 KeV or less, and more specifically within a range of from 0.1 to 16 KeV.

When the incident energy of a monochromatic X-ray beam is 16 KeV with respect to a specimen material, the inner shells of substantially all the elements of from Mg to Pb in the periodic table can be excited. However, it does not mean that the incident energy is sufficient to be always 16 KeV, but since the energy with high excitation efficiency differs dependent on elements, so that when particularly a certain element is to be observed, it is desired that the incident energy is adjusted in response to the absorption end of the element in question.

An incident energy of 0.1 to 5 KeV belongs to a soft X-ray region, so that different effects appear from the case wherein the incident energy of 5 to 16 KeV. Specifically, there is an advantage of improvement in the excitation efficiency. On the other hand, since the absorption around a sample is remarkable, so that it becomes necessary for such alteration of a flowing manner that the environment is kept in a vacuum tank. For instance, in a flowing manner by means of a solvent, since the absorption of soft X-rays is serious, such a manner that a rotating drum is wound with a thin plastic film, a specimen material is fixed to the plastic film expanded therefrom by means of instantaneous cooling or the like, and then, soft X-rays are irradiated onto the specimen material on the plastic film may be applied, however, the essentiality of the manner for discriminating a specified element by utilizing inner shell excitation by means of X-rays is not changed.

Next, the fluorescent X-ray detecting system 18 will be described wherein the fluorescent X-ray detecting system 18 may be composed of, for example, a silicon drift X-ray detector (SDD: silicon drift detector) being a fluorescent X-ray detector of an energy distribution type.

It is to be noted that since heretofore well-known technologies may be applied to the X-ray detector 16, the laser beam irradiating system 20, the forward-scattered light detecting system 22, the side-scattered light detecting system 24, the light detecting system 26, and the batch-off system 28, the heretofore well-known technologies are cited herein; and the detailed explanations therefor are omitted with respect to the constitutions and the functions of these systems.

The forward-scattered light detecting system 22 as well as the side-scattered light detecting system 24 may be composed by the use of, for example, photodiodes and the like, and the light detecting system 26 may be composed by the use of, for example, the condenser lens 26a, the dichroic mirrors 26b, 26c, 26d and 26e, the photomultipliers 26f, 26g, 26h and 26i or the like components.

According to the constitution as described above, in the flow cytometer 10, a forward-scattered light can be detected by the forward-scattered light detecting system 22, a side-scattered light can be detected by the side-scattered light detecting system 24, lights emitted from the labeled coloring matters of a specimen material can be detected by the light detecting system 26, and the predetermined specimen material can be detected by the batch-off system 28 as in the case of a heretofore well-known flow cytometer.

Furthermore, in the flow cytometer 10, a measurement of the respective elements constituting a specimen material can be made as the characteristic features of the present invention as described hereunder. In the following explanation, the case wherein cells are used as a specimen material is described.

Namely, a sample liquid being a solution containing a specimen material (cells) is allowed to flow slowly into the tube 12d of the flow system 12 in an adequate condition; and high-intensity monochromatic X-rays are irradiated to the specimen material (cells) in the tube 12d by means of the monochromatic X-ray irradiating system 14. At the same time, the fluorescent X-rays emitted from the respective elements in the specimen material (cells) in response to the irradiation of the monochromatic X-rays can be detected in a lump by means of the fluorescent detecting system 18.

When the above-described treatment is repeated on a number of specimen materials (cells), the correlation between elements constituting the specimen material can be obtained.

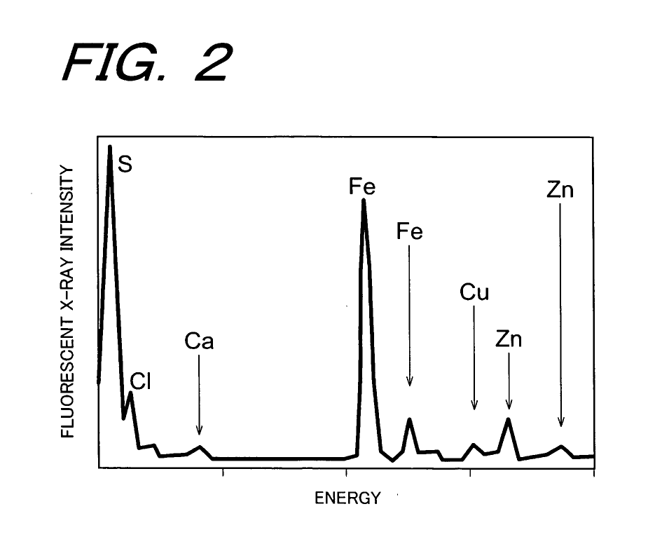

As a result of irradiating once monochromatic X-rays by means of the monochromatic X-ray irradiating system 14, signals (SDD spectra) of substantially all the elements extending from Mg to Pb in the periodic table of elements, for example, as shown in FIG. 2, such as Mg, P, S, Cl, K, Ca, V, Cr, Mn, Fe, Co, Ni, Cu, Zn, Pt, Hg and Pb are obtained in a SDD used as the fluorescent X-ray detecting system 18.

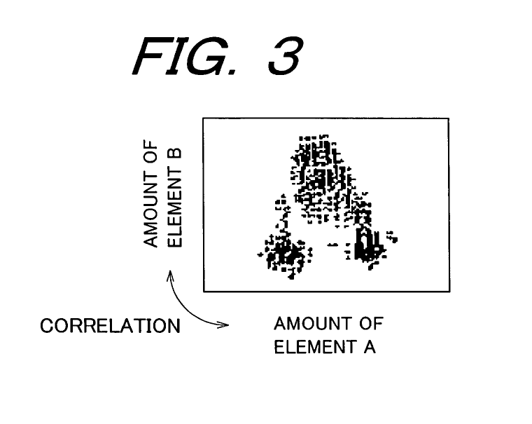

From the SSD spectra as shown in FIG. 2, a histogram indicating a correlated relationship between an element A and an element B as shown in, for example, FIG. 3 may be obtained, whereby it becomes possible to determine correlated relationships between various elements, proteins or DNAs and the like.

Although a measuring time depends upon the density of an element to be measured so that there is a certain tolerance, it is, for example, around 0.01 to 10 seconds per a cell. The period of time for around 0.01 to 10 seconds per a cell is the one sufficient for collecting SDD spectrum in respect of one cell by means of an SSD used as the fluorescent X-ray detecting system 18, and further the period of time is the one for which several hundreds of cells can be measured per one day which has a statistical meaning.

As an appropriate condition for flowing a sample liquid being a solution containing a specimen material (cells) through the tube 12d of the flow system 12, for example, it may be arranged that 100 to 0.1 of a specimen material (cells) are allowed to flow per second in the case when the measuring time is around 0.01 to 10 seconds per one cell.

Incidentally, the monochromatic X-rays irradiated by the monochromatic X-ray irradiating system 14 differs from electron rays in that the former has weak mutual actions with physical matters, resulting in small damages in the cells, so that extremely correct information of a specimen material may be obtained without damaging the specimen material

The flow cytometer 10 differs remarkably from a heretofore well-known flow cytometer in that first, such flow cytometry that fluorescent X-rays are detected, whereby each of “contents of plural elements” is measured with respect to an individual cell among a number of cells can be realized.

On one hand, the flow cytometry wherein the flow cytometer 10 is used is extremely excellent in that a conventional flow cytometry which is characterized by an artificial condition such as an addition of a label coloring matter with respect to a specimen material wherein it must be inevitably relied on an indirect amount, while the elemental information of fluorescent X-rays obtained by the flow cytometry wherein the flow cytometer 10 is used is the natural information to which any factor is not added, besides the information is that measured directly.

Moreover, the flow cytometry wherein the flow cytometer 10 is used is also extremely excellent in that the measuring technology the quantitativeness of which has been already assured in the point of fluorescent X-ray analysis is used, and that also it is measurable in even a minute amount.

In the flow cytometer 10, when a label coloring matter is added to a specimen material, it becomes possible to add significant information relating to element to the data obtained by a conventional flow cytometry without accompanying a further modification.

Such flow cytometry wherein the flow cytometer 10 is used may be utilized, for example, as follows.

For instance, it is suggested that a specified element is concerned with the resistance mechanism of cancer cell with respect to a variety of anti-cancer drugs, in this respect, however, even if it is observed in the tissue level, the cell mechanism is not clear. In these circumstances, two groups of cancer cells one of which belongs to a group wherein the cancer cells have resistance to an anti-cancer drug and the other of which belongs to a group wherein the cancer cells have not resistance to the anti-cancer drug are prepared; and when the correlation between the specified element and an amount of the anti-cancer drug is collected with respect to an individual cell, it becomes possible to clearly elucidate a role of the specified element.

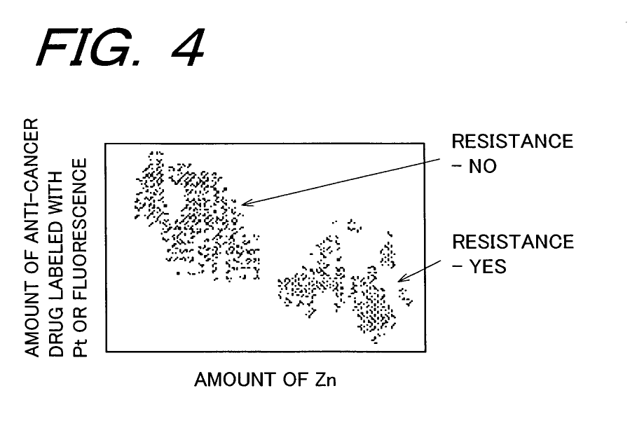

Namely, when differences in the pattern of a histogram as shown in FIG. 4 obtained in accordance with the flow cytometry wherein the flow cytometer 10 is used in response to presence or absence of resistance, presence or absence of the administration of a drug and the like are studied, it becomes possible to verify the drug resistance mechanism of cancer cells with respect to, for example, an anti-cancer drug cisplatin (platinum-containing drug). Namely, it is to collect the correlation between Pt and the metallic element of metallothionein (a metal-binding protein concerned with detoxification), or the like operation.

As described above, according to the flow cytometry wherein the flow cytometer 10 is used, such information “the correlated distribution of an amount of element in cell groups” which could not have been obtained becomes achieved under the high objectivity.

In the flow cytometer 10, a target specimen material (cells) can be separated to batch off the specimen material by means of the batch-off system 28 on the basis of “the correlated distribution of an amount of element in cell groups”.

It is to be noted that the above-described embodiment may be modified into that described in the following paragraphs (1) through (5), respectively.

(1) In the above-described embodiment, although the monochromatic X-rays to be irradiated to a specimen material is obtained from an undulator (high-intensity) beam line in radiant light facilities, the invention is not limited thereto, as a matter of course, but, for example, a monochromatic X-ray light source which can be provided on a table is applicable. In case of a laboratory type (a sealed-off or a rotary anode) X-ray source, it is required to intensify the X-ray intensity, in this respect, it may deal with the requirement by gathering beams which are in capillary and extend over a wide region to increase the intensity (photon density) and by increasing the measuring time.

(2) In the above-described embodiment, although it is arranged to flow a specimen material through the inside of the tube 12d, the invention is not limited thereto, as a matter of course, but the specimen material may be dropped without applying the tube 12d. According to the above-described embodiment, it is possible to arrange in such that monochromatic X-rays are irradiated to an arbitrary specimen material by a predetermined period of time by adjusting the pressure inside the tube 12d, on the other hand, in the case where a specimen material is dropped without applying the tube 12d, it may be arranged in such that liquid drops are allowed to form in an orifice of the flow cell 12b, and monochromatic X-rays are irradiated to these liquid drops.

Particularly, in case of a soft X-ray region, it is possible to take such a manner that a rotating drum is wound with a thin plastic film, a specimen material is fixed to the plastic film expanded therefrom by means of instantaneous cooling or the like, and then, soft X-rays are irradiated onto the specimen material on the plastic film.

(3) In the above-described embodiment, although the case wherein a measuring time is made to be, for example, around 0.01 to 10 seconds per a cell is described, the invention is not limited thereto, as a matter of course, but it may be made to be, for example, 300 seconds per a cell in, particularly, the case of the laboratory type X-ray source described in the above paragraph (1), so that it is possible to measure 200 of cells per one day.

(4) In the above-described embodiment, although the case wherein 100 to 0.1 of a specimen material (cells) are allowed to flow per second is described, the invention is not limited thereto, as a matter of course, but it may be arranged in such that, for example, 0.003 or more of a specimen material is allowed to flow per second in the case where the measuring time is made to be, for example, 300 seconds per a cell as described in the above paragraph (3).

(5) The above-described embodiment may be properly combined with the modifications as described in the above paragraphs (1) through (4).

### INDUSTRIAL APPLICABILITY

The present invention is expected to be applied in respective fields (immunology, biogenetics, protein engineering, molecular biology, cell biology and the like) of biology and experimental medicine, or clinical medicine relating to pathologic diagnosis, or drug discovery and the like; and the technology derived from the invention is applicable to blood analysis, cell markers, cell experiments or pathological analysis and the like.

1. A flow cytometer, characterized in that:
a sample liquid flow generating means for generating a sample liquid flow by flowing a sample liquid containing an object to be measured at a predetermined flow speed;
a monochromatic X-ray applying means for irradiating monochromatic X-rays to the object to be measured in the sample liquid flow generated by said sample liquid flow generating means; and
a fluorescent X-ray detecting means for detecting the fluorescent X-rays emitted from elements constituting the object to be measured in response to the irradiation of the monochromatic X-rays irradiated from said monochromatic X-ray irradiating means to the object to be measured.

2. The flow cytometer as claimed in claim 1, characterized in that:
a beam diameter of the monochromatic X-rays irradiated to the object to be measured from said monochromatic irradiating means is 0.1 μm or more to 500 μm or less.

3. A flow cytometer as claimed in any one of claims 1 or 2, characterized in that
an incident energy of the monochromatic X-ray beams irradiated to the object to be measured from said monochromatic X-ray irradiating means is 0.1 KeV or more to 16 KeV or less.

4. The flow cytometer as claimed in claim 1, characterized in that:
said sample liquid flow generating means flows the sample liquid flow inside a tube;
said monochromatic X-ray irradiating means irradiates monochromatic X-rays to the object to be measured inside said tube; and
a diameter of said tube is 20 to 500 μm.
